(19) United States
(12) Patent Application Publication
(10) Pub. No.: US 2008/0216954 A1
(43) Pub. Date: Sep. 11, 2008

(54) Plastic Welding Compound

(76) Inventor: Larry Dale Hunter, Hansen, ID (US)

Correspondence Address: Larry Dale Hunter, 2441-A Rock Creek Road, Hansen, ID, 83334, US

(21) Appl. No.: 12/033,020

(22) Filed: Feb. 19, 2008

Related U.S. Application Data
(60) Provisional application No. 60/893,502, filed on Mar. 7, 2007.

(51) Int. Cl. B29C 65/74; B05D 7/00; C08L 33/14

(52) U.S. Cl. 156/308.4; 427/181; 525/258; 524/560

(57) ABSTRACT

The invention is a combination of a Methyl Methacrylate liquid monomer and an acrylic powdered polymer that when mixed together will form an extremely strong chemical bond between two plastic substrates by melting into the plastic and filling the space between the substrates. A bond stronger than previously achievable is accomplished by two factors: (1) Substantial use of the liquid as a primer before the application of the mixture in order to prepare the surface for welding. (2) Controlling the temperature of the liquid and the powder, via refrigeration, before mixing. This allows workability of the product without the need for additives that dilute the strength of the mixture. The elimination of the additives also allows for a more pure weld that can be polished to a crystal clear surface for an esthetically pleasing joint.

The present invention relates to a plastic welding compound and method for welding plastics. The invention is comprised of the following components:
Liquid: Methyl Methacrylate (95-100%) and p-Hydroxyanisole Inhibitor (MEHQ)(200 ppm)
Powder: Polyethylmethacrylate (65-99%) Polymethyl Methacrylate (0-35%) and Dibenzoyl Peroxide (0-1%)

The Liquid is applied (brushed, swabbed, sprayed, or other suitable method) to the plastic surface or surfaces to be welded as a primer in order to soften and penetrate the surface of the plastic. Additional liquid is then mixed (in a chemical resistant container such as a paper cup and stirred with a chemical resistant stir stick such as a wooden dowel. Automated mixing equipment could also be used in a production application with the powder in a ratio sufficient to create the desired viscosity of paste (thicker for vertical surfaces to avoid runoff during application or thinner to create a longer work time). To create the thicker viscosity the mix would have a higher ratio of powder, to create a lower viscosity, one would slowly add liquid until the desired viscosity was achieved.). The mixture is then applied to the primed area desired to be welded. The application of the mixture may be done with a tool such as a putty knife, bondo spreader, syringe, or other tool suitable for the particular weld to be created. Automated application equipment may also be used for production uses. The weld should then be allowed to go through a thermal curing cycle. Once cooled, the weld is at full strength. Curing time of the weld is usually from approximately 3-20 minutes. The variables are: the ambient temperature, the temperature of the material to be welded and the temperature of the powder and liquid. The process can be best controlled by controlling as many of these variables as possible. The easiest to control is the liquid and powder temperature as they are easily refrigerated and transported in a portable cooler during hot weather situations. Where possible, such as in a production environment or in a repair situation the ambient temperature and the temperature of the material to be welded can be controlled by working in a building with air conditioning. In a preferred embodiment, the ambient temperature and the temperature of the material to be welded would be approximately 50 degrees Fahrenheit and the liquid and powder would be under 40 degrees Fahrenheit. In an embodiment where preferred temperatures cannot be maintained, a higher liquid ratio will aid in workability of the mixture.

The compound may be used to bond to a non-soluble plastic or other material not soluble with the acrylic liquid by creating a very liquid mixture of the powder and liquid and applying it to a roughened or porous surface and allowing it to cure. The non-soluble material will how have a mechanical bond to a thin layer of acrylic plastic. This plastic layer may now be chemically welded to either a soluble plastic, or another non-soluble material that has also been properly prepped as previously described.

The compound may be used to repair cracked or broken plastic. It may be used to weld new plastic parts together. It may also be used to fill a void in repairing a damaged plastic surface, such as, but not limited to, a blistered or gouged fiberglass boat surface, then it may be sanded, polished and painted. It may also be used to form a mechanical bond between non soluble materials.

While the concept of solvent welding plastic is not new, prior art does not offer the versatility, strength, range of materials or ease of use that this invention provides.

In one prior art, PVC or ABS pipe is swabbed with a solvent then the pipe is inserted into a fitting and allowed to cure. This procedure is limited to a process whereby one part must be inserted into another very close-fitting part of the same material. In contrast the plastic welding compound can weld plastics of different materials, and shapes as well as poorly fitting parts.

Another Prior Art, U.S. Pat. No. 6,103,800 utilizes fillers such as limestone, silica and others to provide for an easier to work with mixture. Unfortunately, adding fillers dilutes the strength of the solvent, thereby creating a weaker bond. The plastic welding compound described here accomplishes workability through temperature control. This method, along with the use of the Methyl Methacrylate liquid as a primer allows for a deeper penetration into the plastic being welded. A wider range of weldable plastics is also realized. The diluted with fillers method, for instance, makes a very poor bond to flexible PVC using platicizers such as di-ethylhexl phthalate, while the plastic welding compound of this invention creates a permanent weld. As an added benefit, the lack of fillers allows the Weld to be polished to a crystal clear finish when desired.

What is claimed is:

1. A method for welding plastic whereby an acrylic liquid is applied to a plastic substrate as a primer to soften the plastic. Then the liquid and an acrylic powder are mixed together to form a paste. Additional priming of the substrate may be performed. The paste is then applied to the seam to be welded. The Acrylic melts into the plastic to form a very strong chemical bond.

2. A composition comprising of a liquid component and a powder component wherein the proportion of liquid to powder is, by weight, between 1 part liquid to 1 part powder, and 5 parts liquid to 1 part powder, wherein: Powder consists of Polyethelmethacrylate (65-95%) Polymethyl Methacrylate (0-35%) and Dibenzoyl Peroxide (0-1%); Liquid consists of Methyl Methacrylate (90-95%) and p-Hydroxyanisole Inhibitor (Mehq)(200 ppm). The higher the liquid in the ratio, the lower the viscosity and the longer the curing time will be.

3. The Composition of claim 2, including 1 or more coloring agents.

4. The liquid component of claim 2, used without the powder as a priming agent to soften the plastic.

5. A kit for the purpose of welding plastic, containing the components in claim 2.

6. a kit such as in claim 5, possibly containing 1 or more coloring agents, mixing devices, containers, and or applicators and instructions for their use.

7. Individually available (not in kit form) liquid and powder components from claim 2 for the purpose of eliminating waste from leftover components.

8. A method for maintaining workability of the mixture during the curing cycle by refrigerating the liquid and powder components described in claim 2 prior to mixing and where possible controlling the ambient and substrate temperatures via air conditioning.

9. The components of claim 2 supplied in bulk form for the purpose of large jobs or production applications.

10. A method of applying the compound whereby, after priming, the powder is applied to the seam with a hollow tube (such as a hypodermic needle), then saturated with the liquid by also applying with a hollow tube. Thereby, the mixing takes place on the weld, as opposed to in a container before the weld. This eliminates the possibility of the paste curing before application to the weld seam.
